(19) United States
(12) Patent Application Publication
(10) Pub. No.: US 2013/0294289 A1
(43) Pub. Date: Nov. 7, 2013

(54) COMMUNICATION BETWEEN WIRELESS NETWORKS

(71) Applicants: Jarkko Kneckt, Espoo (FI); Eng Hwee Ong, Singapore (SG); Mika Kasslin, Espoo (FI); Janne Marin, Espoo (FI)

(72) Inventors: Jarkko Kneckt, Espoo (FI); Eng Hwee Ong, Singapore (SG); Mika Kasslin, Espoo (FI); Janne Marin, Espoo (FI)

(73) Assignee: Nokia Corporation, Espoo (FI)

(21) Appl. No.: 13/980,502

(22) PCT Filed: Jan. 30, 2012
(86) PCT No.: PCT/FI2012/050079

§ 371 Date: Jul. 18, 2013

(30) Foreign Application Priority Data
Feb. 21, 2011 (FI) 20115163

(51) Int. Cl. H04W 72/04

(52) U.S. Cl. CPC H04W 72/0406
USPC 370/254; 370/329

(57) ABSTRACT

Methods, apparatuses, and a computer program are presented for utilizing, by a wireless communication apparatus of a first network, a proxy apparatus of a second network, wherein the channels of the two networks overlap. The proxy apparatus is used to reserve the overlapping channels also in the second network so as to protect data transmissions in the first network and to avoid collisions.

### FIELD

The invention relates to the field of wireless telecommunications and, particularly, to communication between service groups or service sets in a wireless communication system.

### BACKGROUND

Wireless Local Area Network (WLAN) has undergone vast development in order to increase throughput. Task groups such as 802.11b, 802.11a, 802.11g and 802.11n have demonstrated continuous improvement of the WLAN radio throughput. 802.11ac is another task group that is developing the WLAN radios that operate at a frequency spectrum below 6 GHz and especially at 5 GHz. There exist other task groups within the IEEE 802.11 standardization.

### BRIEF DESCRIPTION

According to an aspect of the present invention, there are provided methods as specified in claims 1 and 6.

According to another aspect of the present invention, there are provided apparatuses as specified in claims 13 and 18.

According to another aspect of the present invention, there is provided an apparatus as specified in claim 26.

According to yet another aspect of the present invention, there is provided a computer program product embodied on a computer readable distribution medium as specified in claim 27. According to yet another aspect, there is provided a computer-readable distribution medium comprising the computer program product.

Embodiments of the invention are defined in the dependent claims.

### LIST OF DRAWINGS

Embodiments of the present invention are described below, by way of example only, with reference to the accompanying drawings, in which

FIGS. 1A and 1B illustrate an example of a wireless communication system to which embodiments of the invention may be applied;

FIGS. 2A and 2B illustrate a flow diagram of a process according to an embodiment of the invention;

FIGS. 3 to 5 illustrate initialization of proxy functionality according to an embodiment of the invention;

FIGS. 6 and 7 illustrate communication with respect to protecting data transmission in overlapping basic service sets;

FIG. 8 illustrates a flow diagram of a process for determining how to respond to a received transmission request message; and

FIG. 9 illustrates a block diagram of an apparatus according to an embodiment of the invention.

### DESCRIPTION OF EMBODIMENTS

The following embodiments are exemplary. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned.

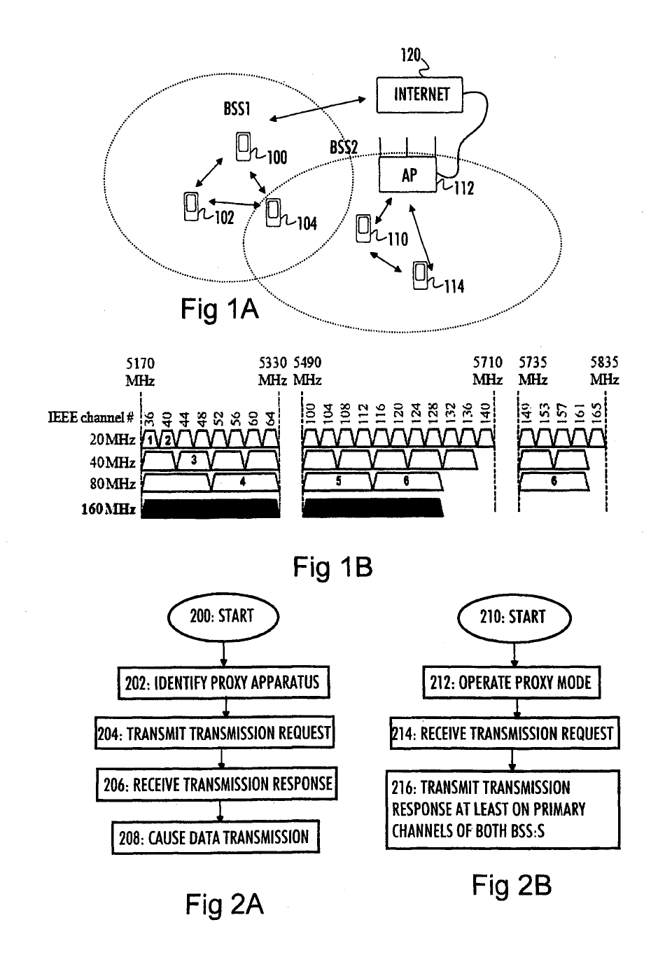

A general architecture of a wireless telecommunication system to which embodiments of the invention may be applied is illustrated in FIG. 1A. FIG. 1A illustrates two groups of wireless communication devices forming two basic service sets, e.g. groups of wireless communication devices comprising an access point (AP) 100, 112 and terminal stations (STA) 102, 104, 110, 114 communicating with the access points 100, 112 of their respective groups. A basic service set (BSS) is a basic building block of an IEEE 802.11 wireless local area network (WLAN). The most common BSS type is an infrastructure BSS that includes a single AP together with all associated STAs. The AP may be a fixed AP as AP 112, or it may be a mobile AP as AP 100. The APs 100, 112 may also provide access to other networks, e.g. the Internet 120. In another embodiment, at least one of the BSSs is an independent BSS (IBSS) or a mesh BSS (MBSS) without a dedicated AP, and in such embodiments the communication device 100 may be a non-access-point terminal station. While embodiments of the invention are described in the context of the above-described topologies of IEEE 802.11 and, particularly, IEEE 802.11ac, it should be appreciated that other embodiments of the invention are applicable to networks based on other specifications, e.g. other versions of the IEEE 802.11, WiMAX (Worldwide Interoperability for Microwave Access), UMTS LTE (Long-term Evolution for Universal Mobile Telecommunication System), and other networks having cognitive radio features, e.g. transmission medium sensing features and adaptiveness to coexist with radio access networks based on different specifications and/or standards.

The 802.11n specifies a data transmission mode that includes 20 MHz wide primary and secondary channels. The primary channel is used in all data transmissions, and with clients supporting only the 20 MHz mode. A further definition in 802.11n is that the primary and secondary channels are adjacent. The 802.11n specification also defines a mode in which a STA can have only one secondary channel which results in a maximum bandwidth of 40 MHz. IEEE 802.11ac task group extends such an operation model to provide for wider bandwidths by increasing the number of secondary channels from 1 up to 7, thus resulting in bandwidths of 20 MHz, 40 MHz, 80 MHz, and 160 MHz. FIG. 1B illustrates an exemplary channel structure for 20 MHz, 40 MHz, 80 MHz, and 160 MHz channels. In this example, a 40 MHz transmission band is formed by two contiguous 20 MHz bands (denoted by numerals 1 and 2 in FIG. 1B), and an 80 MHz transmission band is formed by two contiguous 40 MHz bands (numerals 1, 2, 3). However, a 160 MHz band may be formed by two contiguous (numerals 1 to 4) or non-contiguous 80 MHz bands (numerals 1 to 3 for a first 80 MHz band and any one of bands denoted by numerals 5 and 6 for a second 80 MHz band).

As mentioned above, the transmission band of a BSS contains the primary channel and zero or more secondary channels. The secondary channels may be used to increase data transfer capacity of the TXOP. The secondary channels may be called a secondary channel, a tertiary channel, a quaternary channel, etc. The primary channel may be used for channel contention, and a transmission opportunity (TXOP) may be gained after successful channel contention on the primary channel. Every STA is reducing a backoff value while the primary channel is sensed to be idle for a certain time interval, for instance 9 microseconds. When the backoff reaches zero, the STA gains the TXOP and starts transmission. If another STA gains the TXOP before that, the channel sensing is suspended, and the STA proceeds with the channel sensing after the TXOP of the other STA has ended. The time duration (the backoff factor) may not be reset at this stage, and the time duration that already lapsed before the suspension is also counted, which means that the STA now has a higher probability of gaining the TXOP. A secondary channel may be used in the transmission if it has been free for a determined time period (may be the same or different time period than that used for gaining the TXOP) just before TXOP start time in order for the contending STA to take the secondary channel in use.

A virtual carrier sensing function is provided by the provision of a network allocation vector (NAV) which is used to reserve a channel. Most of the transmitted frames comprise a duration field which can be used to reserve the medium (or provide duration of the NAV protection) for the duration indicated by the value of the duration field. In practice, the NAV is a timer that indicates the amount of time the medium will be reserved. In a typical operation, the transmitting and receiving stations (STAs) will set the NAV to the time for which they expect to use the medium while other STAs count down from the NAV to zero before starting the channel contention. The virtual carrier sensing function indicates that the medium is busy when NAV is non-zero and idle when NAV is zero. The NAV may be set to protect frames communicated on the primary channel of the BSS.

Referring back to FIG. 1A, the two BSSs (BSS1 and BSS2) are illustrated as having overlapping coverage areas which means that they potentially interfere with one another. It should be noted that the coverage areas may overlap completely and/or partially, while only the partial overlapping is illustrated in FIG. 1A. Interference may exist when the two BSSs have at least one common frequency channel. In some scenarios, the interference may occur when at least a primary channel of a first BSS is located on a secondary channel of a second BSS. The NAV may be maintained only on the primary channel of each BSS and, therefore, if a STA of the second BSS does not monitor the primary channel of the first BSS, it may not detect the active NAV protection of the first BSS and carry out a transmission which may interfere with the first BSS having at least one of its secondary channels on the primary channel of the second BSS. Other similar interference scenarios may exist. Methods according to some embodiments of the invention realize the NAV protection on primary channels of both BSSs having overlapping channels and coverage areas, thereby reducing the interference and improving the reliability of transmissions. FIGS. 2A and 2B illustrate embodiments of processes for protecting the data transmissions. FIG. 2A illustrates a process where a TXOP holder, e.g. a wireless communication apparatus of a first BSS that has gained the TXOP to carry out a data transmission to a receiver apparatus, and protects the data transmission by utilizing a proxy apparatus of a second BSS to relay the protection to the second BSS. FIG. 2B illustrates a flow diagram of a process carried out in the proxy apparatus. The first BSS and the second BSS may have overlapping sets of frequency channels, wherein the frequency channels may overlap partially. The primary channels of the BSSs may, however, be located on different frequency channels. In some embodiments, the primary channel of the second BSS may overlap the channels of the first BSS.

Referring to FIG. 2A, the process starts in block 200. In block 202, the TXOP holder identifies a proxy apparatus of the second BSS, and the TXOP holder is arranged to transmit a transmission request message, e.g. a Request-to-Send (RTS) message, to the identified proxy apparatus on at least a primary channel of the first BSS and on the primary channel of the second BSS in block 204. The RTS frame may be transmitted only, if the NAV is not already set at the RTS transmitter operating at the primary channel of the first BSS. In block 206, the TXOP holder receives a transmission response message, e.g. a Clear-to-Send (CTS) message, from the proxy apparatus as a response to the transmission request message. The transmission of the CTS frame may be prevented, if the NAV is already set at the proxy apparatus operating on the primary channel of the second BSS. Upon reception of the transmission response message, the TXOP holder is arranged to transmit data to the receiver apparatus of the first basic service set in block 208. The transmission response message may set the NAV protection (or similar transmission protection) at least on the primary channel of the second BSS, while at least the transmission request message sets the NAV protection in the first BSS. Therefore, the transmission may be protected in both overlapping BSSs.

Referring to FIG. 2B, the process of the proxy apparatus starts in block 210. In block 212, the proxy apparatus is configured to operate in a proxy mode in which the proxy apparatus communicates with wireless communication apparatuses of another BSS. The proxy mode may be a fixed mode (the proxy mode is always on) or it may be switched on and off upon initiation by the proxy apparatus itself or through signaling with an AP of the BSS of the proxy apparatus. In block 214, the proxy apparatus receives, from the TXOP holder at least on the primary channel of the second BSS (the primary channel of the proxy apparatus), a transmission request message querying availability of at least channels indicated in the transmission request message for data transmission. In block 216, the proxy apparatus is arranged to transmit a transmission response message as a response to the transmission response message to the TXOP holder at least on the primary channel of the second basic service set. In some embodiments, the transmission response message is transmitted on all channels queried in the transmission request message and detected to be available by the proxy apparatus.

As mentioned above, the primary channel of the second BSS (the BSS of the proxy apparatus) may be located on the channel set of the first BSS, and the RTS message may be transmitted to the proxy apparatus on the channels of the first BSS including the primary channel of the second BSS. In such embodiments, both the TXOP holder and the proxy apparatus may operate only on the channels of their respective BSSs, and the proxy apparatus may respond with the CTS message only on its primary channel and, optionally, on any auxiliary channel queried in the transmission request message that is common to both BSSs. The RTS message sets the NAV on both primary channels, and the CTS message may be used to verify the existence of the RTS NAV and indicate that the primary channel of the second BSS is available for the data transmission. In other embodiments where the primary channel of the second BSS is outside the frequency channels of the first BSS, the TXOP holder may identify in block 202 also the primary channel of the second BSS and transmit the RTS message to the proxy apparatus on the primary channel of the second BSS.

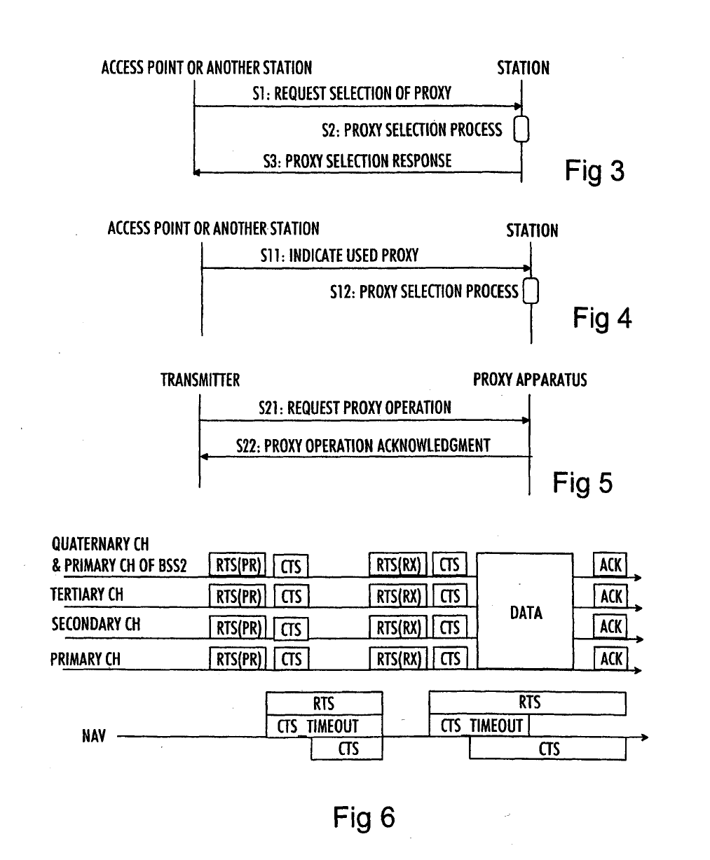

Let us now consider some embodiments for initializing the proxy selection and proxy operation with reference to FIGS. 3 to 5. In some embodiments, an AP or another STA requests a STA to utilize the proxy apparatus of another BSS, while in other embodiments the STA may autonomously determine to utilize the proxy apparatus. FIG. 3 illustrates an embodiment for the proxy selection initiated by the AP or the other STA, e.g. a peer mesh STA, but let us for clarity's sake describe the operation by using the AP as an example. Referring to FIG. 3, the AP transmits in S1 a message requesting the STA to select a proxy apparatus for use when carrying out data transmissions. The request message may indicate at least one candidate proxy apparatus, and the request message may have the following structure:

TABLE 1

| | | # of | | | Proxy |
|---|---|---|---|---|---|
| Element | | Proxy | Proxy | | Element |
| ID | Length | Elements | Element #1 | . . . | #N |
| 1 | 1 | 1 | X | . . . | Y |

The Element ID is set to unique value as specified in 802.11ac.

The length of the field is set to the size of the information element excluding the Element ID and Length fields.

The number of Proxy Elements field is an unsigned integer and set to the number of Proxy Candidate elements. Each proxy candidate element may have the following structure:

TABLE 2

| | | Offset | | MAC | | MAC |
|---|---|---|---|---|---|---|
| | | of | | of | | of |
| Element | | Primary | # of Proxy | Proxy | | Proxy |
| ID | Length | Ch | Candidates | #1 | . . . | #N |
| 1 | 1 | 1 | 1 | 6 | . . . | 6 |

Offset of Primary Channels indicates the offset between the primary channels of the first and the second BSS, and it may be a signed integer (the sign indicating the direction of the offset) utilizing the channel numbering, e.g. one illustrated in FIG. 1B. For example, −8 may indicate that the primary channel of the proxy candidates is on a channel indexed 8 lower than the corresponding index of the primary channel of the first BSS. The number of proxy candidates field indicates the number of proxy candidates included in the request message, and the MAC (Medium Access Control) addresses of the candidate proxies may be defined in subsequent fields. The number below each field in Tables 1 and 2 indicates the length of each field in terms of the number of octets. The AP may be configured to select the candidate proxies of the second BSS on the basis of at least one of the following criteria: the proxy candidate is 802.11ac capable device, i.e. capable to operate in multiple channels, performing CCA to multiple channels; the proxy candidate is an AP of the second BSS (AP may be selected over a STA as the proxy candidate); the proxy candidate is operating in an active mode; the proxy candidate is selected from a BSS that has a primary channel closest to the primary channel of the first BSS (e.g. a BSS having the primary channel located on the secondary channel is preferred over a BSS having the primary channel on the tertiary channel); and location of the proxy candidates with respect to the STA to which the request message is transmitted. The AP may determine the location of the proxy candidates with respect to the STA by using beamforming techniques, e.g. by scanning for the proxy candidates by using different beamforming settings towards the second BSS while determining the location of the STA through transmissions using the beamforming within the first BSS. It should be noted that Tables 1 and 2 allow bundling the proxy apparatuses into the proxy elements. The bundling may be based on, for example, by arranging proxy candidates of different BSSs into different proxy elements (proxy candidates of the same BSS in the same proxy element). However, in some embodiments where the proxy candidates are selected only from a single BSS, Table 1 may be omitted and, instead, only Table 2 may be applied.

Upon reception of the request message from the AP, the STA may carry out a proxy selection process in S2. In the proxy selection process, the STA may be configured to select at least one of the proxy candidates. The selection may be made based on channel sounding on at least one of the overlapping channels so as to detect a transmission from any one of the proxy candidates. The STA may be configured to monitor for a physical layer convergence protocol (PLCP) header comprised at the head of every transmission. The PLCP header or a MAC header associated with the PLCP header may comprise an identifier of its transmitter and, thus, it enables the STA to determine whether the transmitted is one of the proxy candidates by analyzing the PLCP header and/or the MAC header. The STA may select one of the candidate proxies it is able to detect. The STA may also prioritize the proxy candidates, e.g. an AP proxy may be preferred.

In S3, the STA transmits a proxy selection response message to the AP, indicating the selected proxy candidate. The proxy selection response message may include the MAC address of the selected proxy as shown in the following exemplary format in the proxy selection response message:

TABLE 3

| Element ID | Length | MAC of proxy | Offset of Primary Ch |
|---|---|---|---|
| 1 | 1 | 6 | 1 |

Upon detection of no proxy candidate, the STA may set the MAC address field of the proxy selection response message to zero. Then, the AP may reiterate the process of FIG. 3 to reattempt the proxy selection. The Offset of Primary Channel is the above-mentioned signed offset between the primary channels of the first and second BSS. The offset of the primary channel may be omitted in embodiments where the proxy candidates are from a single BSS. It should be noted that the primary channel of the proxy apparatus may be indicated by other means in every embodiment, e.g. by transmitting an explicit channel index.

In another embodiment, the AP (or a mesh STA or another apparatus of the first BSS) indicates a proxy apparatus the AP itself currently uses. Referring to FIG. 4, the AP may transmit in S11 a proxy indication message to the STA, wherein the proxy indication message may have the same format as indicated in Table 3.

The proxy indication message may include the MAC address of at least one proxy the AP currently uses and the proxy indication message may be comprised in a beacon frame transmitted periodically by the AP and/or in a Probe Response message transmitted in response to a Probe Request message received from the STA. Upon reception of the proxy indication message, the STA may derive the MAC address of the proxy apparatus from the proxy indication message and start using the proxy apparatus by addressing the RTS messages to it prior to a data transmission.

It should be noted that a plurality of proxy apparatuses may be selected. The STA may select a proxy apparatus for every receiver apparatus to which it transmits data, and such a set of proxy apparatuses may include multiple proxies. A different proxy apparatus may be selected for different receivers, or the same proxy may be used for multiple receivers. Moreover, the different proxies may be even in different BSSs all having the overlapping frequency spectrum with the first BSS. Still further, the STA may use a different proxy apparatus when transmitting data to the AP from the proxy used when transmitting data to another STA of the first BSS. The proxy to use with the AP may be selected to be the same proxy the AP uses, while another criterion may be used for selecting a proxy for the STA-STA data transmissions.

Let us now consider signaling with respect to initiating the proxy operation between a transmitter apparatus of the first BSS (STA or AP), and the proxy apparatus of the second BSS. Referring the FIG. 5, the transmitter apparatus transmits in S21 a request for proxy operation to the proxy apparatus on the primary channel of the proxy apparatus and/or on the primary channel of the transmitter apparatus. The transmitter apparatus may include the MAC address of the proxy apparatus in a header of the request, and the MAC address may be selected according to any above-described embodiment for selecting the proxy apparatus. The request may have the following format:

TABLE 4

| | | Offset of the | Type of |
|---|---|---|---|
| Element ID | Length | Primary Ch | Requesting STA |
| 1 | 1 | 1 | 1 |

The request message may define the offset between the primary channels and a type of the STA transmitting the request. The octet of the Type field may have the following bit format:

TABLE 5

| Non-AP | | | Group | | |
|---|---|---|---|---|---|
| STA | AP | Mesh STA | Owner | IBSS | Reserved |
| 1 | 1 | 1 | 1 | 1 | 3 |

Each bit may be set to one value when the corresponding operation mode is currently applied by the STA (e.g. 1), and set to the other value (e.g. 0) otherwise.

Upon reception of the request message having the information elements of Table 4, the proxy apparatus may process the request and determine whether or not it can approve the request. The proxy apparatus may check, for example, the number of apparatus with which it currently provides the proxy service with respect to the maximum number of serviced apparatuses. Other criteria may also be used when determining whether or not to approve the request. Upon determining the result of the check, the proxy apparatus transmits in S22 a proxy operation response message to the transmitter, wherein the response message indicates whether or not the request of S21 was approved or denied. Upon reception of the approval, the transmitter starts to utilize the proxy apparatus and, otherwise, the transmitter may try to request another proxy apparatus to operate as the proxy for the transmitter. The operation of FIG. 5 may be carried out during S2 of FIG. 3 or S12 of FIG. 4, or it may be carried out after S3 of FIG. 3.

With respect to the control messages related to the initializing the proxy operation, correct reception of any message may be acknowledged by an acknowledgment message.

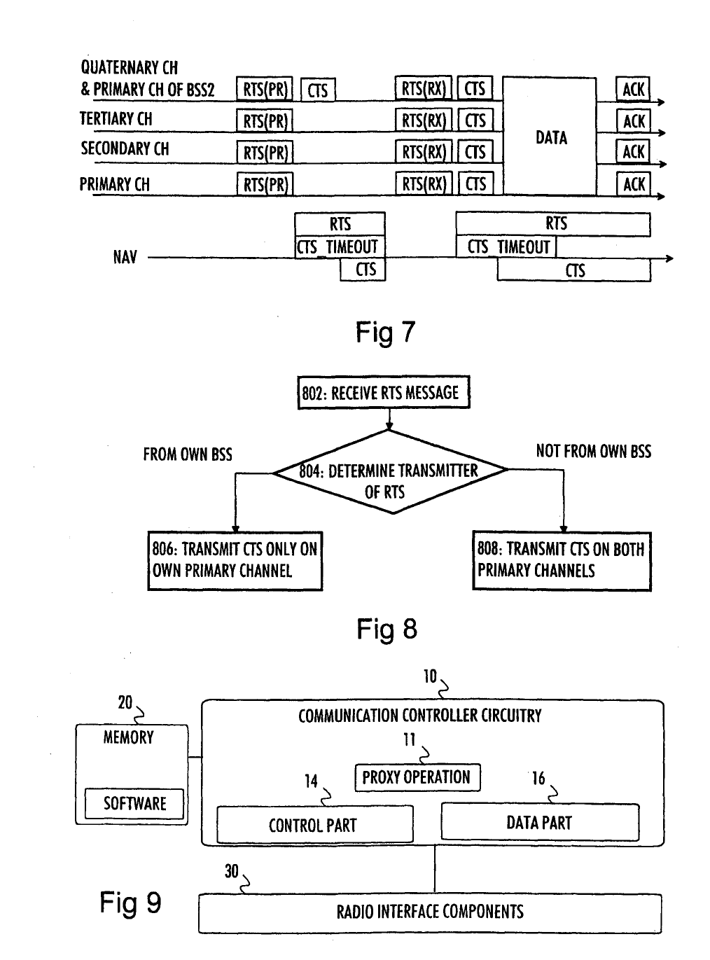

Upon successful proxy initiation and gaining the TXOP, the transmitter apparatus (the TXOP holder) may be configured to transmit the RTS messages at least to the proxy apparatus before the data transmission so as to protect the data transmission in both the first BSS and the second BSS. Let us consider embodiments of such a process with reference to FIGS. 6 and 7. FIG. 6 illustrates a case where the primary channel of the proxy apparatus is located on a quaternary channel of the TXOP holder's BSS. Referring to FIG. 6, the TXOP holder may first transmit the RTS message to the proxy apparatus on the primary to quaternary channels of the first BSS. The RTS message may be sent as a plurality of copies, wherein each copy is transmitted on a different channel. The RTS message may specify a bandwidth of 80 MHz which corresponds to the combined bandwidth of the primary to quaternary channels and which triggers the proxy apparatus to transmit the CTS message on the primary to quaternary channels. The RTS message also includes a Duration field which may be used to define the duration of the NAV protection achievable with the RTS message. This is shown by RTS on the NAV line in FIG. 6. The NAV protection set by the RTS message may be conditional in the sense that the NAV protection needs to be validated by the transmission of the CTS or another message within a time period defined by a CTS_Timeout parameter (may be a system-specific parameter). If the CTS or the other message is not transmitted within the CTS_Timeout, the NAV protection set by the RTS message expires after the CTS_Timeout. In this example, the Duration field of the RTS message is set as the same as the CTS_Timeout, or it may be set even shorter, as the CTS_Timeout is nevertheless the shortest NAV protection gained with the RTS transmission.

Upon reception of the RTS message, the proxy apparatus may first evaluate whether or not the channels queried with the RTS are free. This may include the clear-channel assessment (CCA) in which the proxy apparatus scans the channel(s) for a determined time period so as to detect ongoing radio transmissions. It may also (or alternatively) include determination of current NAV protections on the queried channels, at least the primary channel of the second BSS. Upon detection of no other transmissions, the proxy apparatus may transmit the CTS message to the TXOP holder (the CTS message may include only the receiver address field without a transmitter address field) on the channels queried with the RTS message and detected to be available for the data transmission.

The NAV protection gained by the RTS transmission to the proxy apparatus may extend to protect a subsequent transmission by the TXOP holder, as illustrated in FIG. 6. The subsequent transmission may comprise transmission of another RTS message which is addressed to an intended receiver of the data transmission. The RTS may be transmitted on the channels intended for the data transmission, e.g. primary to quaternary as illustrated in FIG. 6. The Duration field of the RTS message again sets the NAV protection and, since the RTS transmission precedes a data transmission, the NAV protection may be extended to cover the data transmission as well, e.g. the value of the Duration field may be longer than the CTS_Timeout. Upon reception of the RTS message, the receiver may carry out the CCA and NAV detection so as to determine available channels and transmit a CTS message appropriately, as illustrated in FIG. 6. The NAV protection gained with the RTS/CTS handshake with the proxy apparatus may be designed to stop before the CTS transmission by the receiver to enable that CTS transmission. The transmission of the CTS message by the receiver within the CTS_Timeout validates the NAV protection of the RTS message, and data transmission may be carried out thereafter. The data transmission may be acknowledged, as illustrated in FIG. 6.

FIG. 7 illustrates another embodiment in which the TXOP holder transmits the RTS message to the proxy apparatus, as described above with reference to FIG. 6, but the RTS message(s) transmitted on each channel (primary to quaternary channel) may specify a 20 MHz bandwidth corresponding to the bandwidth of each channel. This may trigger the proxy apparatus to transmit the CTS message only on its primary channel (the primary channel of the second BSS). The NAV protection gained with the RTS transmission is the same as in the above-described embodiment, as the channels of the first BSS are still protected for the duration of the CTS_Timeout even though the proxy apparatus does not transmit the CTS message on all the channels on which the RTS message was transmitted. An example of a modification to this embodiment is that the proxy apparatus is configured to transmit the CTS message only on the primary channels of both BSSs. The proxy signaling with proxy apparatus(es) may be repeated multiple times. At maximum each secondary channel may have a proxy STA with separate primary channel and the RTS/CTS exchange may be done with every STA. Multiple RTS/CTS message exchanges procedures may be performed to ensure that there are no NAV violations on any channel.

After the RTS/CTS handshake with the proxy apparatus(es), the procedure may be similar to that of FIG. 6.

Let us now describe criteria related to the transmission of the CTS message from the proxy apparatus upon reception of the RTS message and upon carrying out the CCA and/or NAV detection. A static and a dynamic reservation type may be defined, wherein the static reservation type may refer to proceeding with the data transmission if all the channels indicated in the RTS message are detected as free also by the proxy apparatus. The dynamic reservation type may refer to proceeding with the transmission when a subset of the channels indicated in the RTS message is detected to be free by the proxy apparatus. The reservation type may be indicated in the RTS message. With respect to the dynamic and/or static reservation type, a minimum number of free channels needed to carry out the data transmission may be defined in the RTS message, or it may be defined as a default value in the proxy apparatus, e.g. the number of free channels in the receiver with respect to the number free channels on which the RTS was received. For instance, if the RTS message has commanded the proxy apparatus to apply the static reservation type, e.g. all or a given subset of the queried resources need to be free to proceed with the data transmission, the proxy apparatus may transmit the CTS frame only if all the queried channels are sensed to be idle. If the RTS message commands the dynamic reservation type, e.g. command to reserve any available resource, the proxy apparatus may determine that the TXOP proceeds to the data transmission if any or a given subset of channels is free. If the subset of channels is free, the proxy apparatus transmits the CTS message on the free channels, including the primary channel(s).

The proxy apparatus may be configured to discriminate the RTS messages received from a transmitter of own BSS from RTS messages received from a transmitter of another BSS, and determine the channels on which to transmit the CTS accordingly. For example, the proxy apparatus may monitor only for its primary channel for the RTS messages, while it may have to transmit the CTS message only on the monitored primary channel or also on the primary channel of the other BSS outside the monitored channels. FIG. 8 illustrates a flow diagram of such a process for determining the channel on which to respond to the received RTS message. Referring to FIG. 8, the proxy apparatus receives the RTS message at least (or only) on the primary channel of the BSS of the proxy apparatus in block 802. In block 804, the proxy apparatus determines the transmitter of the RTS from a transmitter field of the received RTS message. If the RTS message is detected to be transmitted from a transmitter (an AP or a STA) of the BSS of the proxy apparatus, the proxy apparatus is configured to transmit the CTS only on those channels of the BSS of the proxy apparatus related to the RTS message in block 806). On the other hand, if the RTS message is detected to be transmitted from a transmitter (an AP or a STA) of another BSS, the proxy apparatus is configured to transmit the CTS message on the primary channel of its own BSS and at least on the primary channel of the BSS of the transmitter in block 808, wherein the primary channel of the transmitter's BSS may be outside the frequency channels of the BSS of the proxy apparatus.

FIG. 9 illustrates an embodiment of an apparatus comprising means for carrying out the above-mentioned functionalities of the TXOP holder and/or the proxy apparatus. The apparatus may be a communication apparatus of an IEEE 802.11 network or another wireless network, e.g. an AP or STA. The apparatus may be a computer (PC), a laptop, a tabloid computer, a cellular phone, a palm computer, a fixed base station operating as the AP, or any other apparatus provided with radio communication capability. In another embodiment, the apparatus is comprised in such a communication apparatus, e.g. the apparatus may comprise a circuitry, e.g. a chip, a processor, a micro controller, or a combination of such circuitries in the communication apparatus.

The apparatus may comprise a communication controller circuitry 10 configured to control the communications in the communication apparatus. The communication controller circuitry 10 may comprise a control part 14 handling control signaling communication with respect to transmission, reception, and extraction of control frames including the transmission request messages and the transmission response messages, as described above. The communication controller circuitry 10 may further comprise a data part 16 that handles transmission and reception of payload data during transmission opportunities of the communication apparatus (transmission) or transmission opportunities of other communication apparatuses (reception). The communication controller circuitry 10 further comprise a proxy operation circuitry 11 configured to carry out the above-described functionalities of the proxy apparatus and/or the TXOP holder selecting the proxy apparatus and communicating with the proxy apparatus.

The circuitries 11 to 16 of the communication controller circuitry 10 may be carried out by the one or more physical circuitries or processors. In practice, the different circuitries may be realized by different computer program modules. Depending on the specifications and the design of the apparatus, the apparatus may comprise some of the circuitries 11 to 16 or all of them.

The apparatus may further comprise the memory 20 that stores computer programs (software) configuring the apparatus to perform the above-described functionalities of the communication device. The memory 20 may also store communication parameters and other information needed for the wireless communications. The apparatus may further comprise radio interface components 30 providing the apparatus with radio communication capabilities within the BSS and with other BSSs. The radio interface components 30 may comprise standard well-known components such as amplifier, filter, frequency-converter, (de)modulator, and encoder/decoder circuitries and one or more antennas. The apparatus may further comprise a user interface enabling interaction with the user of the communication device. The user interface may comprise a display, a keypad or a keyboard, a loudspeaker, etc.

In an embodiment, the apparatus carrying out the embodiments of the invention in the communication apparatus comprises at least one processor and at least one memory including a computer program code, wherein the at least one memory and the computer program code are configured, with the at least one processor, to cause the apparatus to carry out the steps of any one of the processes of FIGS. 2A and 2B. In further embodiments, the at least one memory and the computer program code are configured, with the at least one processor, to cause the apparatus to carry out any one of the embodiments related to utilizing the proxy apparatus to protect the data transmission, as described above in connection with FIGS. 2A to 8. Accordingly, the at least one processor, the memory, and the computer program code form processing means for carrying out embodiments of the present invention in the wireless communication apparatus.

As used in this application, the term ‘circuitry’ refers to all of the following: (a) hardware-only circuit implementations, such as implementations in only analog and/or digital circuitry, and (b) to combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) to circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular element, a baseband integrated circuit or applications processor integrated circuit for a mobile phone or a similar integrated circuit in server, a cellular network device, or other network device.

The processes or methods described in FIGS. 2A to 8 may also be carried out in the form of a computer process defined by a computer program. The computer program may be in source code form, object code form, or in some intermediate form, and it may be stored in a transitory or a non-transitory carrier, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital processing unit or it may be distributed amongst a number of processing units.

The present invention is applicable to wireless telecommunication systems defined above but also to other suitable telecommunication systems. The protocols used, the specifications of mobile telecommunication systems, their network elements and subscriber terminals, develop rapidly. Such development may require extra changes to the described embodiments. Therefore, all words and expressions should be interpreted broadly and they are intended to illustrate, not to restrict, the embodiment. It will be obvious to a person skilled in the art that, as technology advances, the inventive concept can be implemented in various ways. The invention and its embodiments are not limited to the examples described above but may vary within the scope of the claims.

1-27. (canceled)

28. A method, comprising:
identifying, in a wireless communication apparatus of a first network having a first set of frequency channels, a proxy apparatus of a second network having a second set of frequency channels, wherein the second set of frequency channels overlaps at least partially with the first set of frequency channels;
causing the wireless communication apparatus to transmit a transmission request message to the identified proxy apparatus on at least a primary channel of the first network and on a primary channel of the second network;
receiving a transmission response message from the proxy apparatus as a response to the transmission request message; and
upon reception of the transmission response message, causing the wireless communication apparatus to transmit data to a receiver apparatus of the first network.

29. The method of claim 28, further comprising:
receiving a list of candidate proxy apparatuses and primary channel information of the candidate proxy apparatuses; and
selecting the proxy apparatus from the list of candidate proxy apparatuses according to a determined criterion and utilizing the primary channel information in communication with the selected proxy apparatus.

30. The method of claim 28, wherein the method is carried out during a transmission opportunity of the wireless communication apparatus, the further comprising:
causing the wireless communication apparatus to transmit a second transmission request message addressed to the receiver apparatus during the transmission opportunity;
upon reception of a second transmission response message from the receiver apparatus in response to the second transmission request message, causing the wireless communication apparatus to transmit the data to the receiver apparatus during the transmission opportunity.

31. The method of claim 28, further comprising:
receiving from an access point of the first network a message comprising an information element identifying a proxy apparatus the access point is currently using; and
causing the transmission of the transmission request message to the proxy apparatus identified in the message received from the access point.

32. A method, comprising:
configuring a wireless communication apparatus of a first network to operate in a proxy mode in which the wireless communication apparatus communicates with wireless communication apparatuses of a second network, wherein a set of frequency channels of the first network overlaps with a set of frequency channels of the second network;
receiving, from a transmitter apparatus of the second network at least on the primary channel of the first network, a transmission request message querying availability of at least said primary channel for data transmission;
causing the wireless communication apparatus to transmit a transmission response message as a response to the transmission response message to the transmitter apparatus at least on the primary channel of the first network, wherein the transmission response message indicates at least one channel the proxy apparatus has detected as available for the data transmission.

33. The method of claim 32, further comprising:
determining an identity of the transmitter apparatus from which the transmission request message was received;
if the transmitter apparatus is identified as not belonging to the first network, causing the wireless communication apparatus to transmit the transmission response message to the transmitter apparatus at least on the primary channel of the first network and on the primary channel of the second network.

34. The method of claim 33, further comprising:
if the transmitter apparatus is identified as belonging to the first network, causing the wireless communication apparatus to transmit the transmission response message to the transmitter apparatus at least on the primary channel of the first network and not on the primary channel of the second network.

35. The method of claim 32, further comprising:
determining from contents of the received transmission request message, a transmission criteria for transmitting the transmission response message; and
causing the wireless communication apparatus to transmit the transmission response message to the transmitter apparatus if the transmission criteria is fulfilled.

36. The method of claim 28, wherein the first network and the second network each form a basic service set of an IEEE 802.11 network.

37. The method of claim 28, wherein the transmission request message and the transmission response message are used to reserve designated at least one frequency channel for said data transmission.

38. An apparatus comprising:
at least one processor; and
at least one memory including a computer program code, wherein the at least one memory and the computer program code are configured, with the at least one processor, to cause the apparatus to:
identify, for a wireless communication apparatus of a first network having a first set of frequency channels, a proxy apparatus of a second network having a second set of frequency channels, wherein the second set of frequency channels overlaps at least partially with the first set of frequency channels;
cause the wireless communication apparatus to transmit a transmission request message to the identified proxy apparatus on at least a primary channel of the first network and on a primary channel of the second network;
receive a transmission response message from the proxy apparatus as a response to the transmission request message; and
upon reception of the transmission response message, cause the wireless communication apparatus to transmit data to a receiver apparatus of the first network.

39. The apparatus of claim 38, wherein the at least one memory and the computer program code are configured, with the at least one processor, to cause the apparatus to:
receive a list of candidate proxy apparatuses and primary channel information of the candidate proxy apparatuses; and
select the proxy apparatus from the list of candidate proxy apparatuses according to a determined criterion and utilizing the primary channel information in communication with the selected proxy apparatus.

40. The apparatus of claim 38, wherein the at least one memory and the computer program code are configured, with the at least one processor, to cause the apparatus to:
carry out said transmission and reception during a transmission opportunity of the wireless communication apparatus,
cause the wireless communication apparatus to transmit a second transmission request message addressed to the receiver apparatus during the transmission opportunity;
upon reception of a second transmission response message from the receiver apparatus in response to the second transmission request message, cause the wireless communication apparatus to transmit the data to the receiver apparatus during the transmission opportunity.

41. The apparatus of claim 38, wherein the at least one memory and the computer program code are configured, with the at least one processor, to cause the apparatus to:
receive from an access point of the first network a message comprising an information element identifying a proxy apparatus the access point is currently using; and
cause the transmission of the transmission request message to the proxy apparatus identified in the message received from the access point.

42. An apparatus comprising:
at least one processor; and
at least one memory including a computer program code, wherein the at least one memory and the computer program code are configured, with the at least one processor, to cause the apparatus to:
configure a wireless communication apparatus of a first network to operate in a proxy mode in which the wireless communication apparatus communicates with wireless communication apparatuses of a second network, wherein a set of frequency channels of the first network overlaps with a set of frequency channels of the second network;
receive, from a transmitter apparatus of the second network at least on the primary channel of the first network, a transmission request message querying availability of at least said primary channel for data transmission;
cause the wireless communication apparatus to transmit a transmission response message as a response to the transmission response message to the transmitter apparatus at least on the primary channel of the first network, wherein the transmission response message indicates at least one channel the proxy apparatus has detected as available for the data transmission.

43. The apparatus of claim 42, wherein the at least one memory and the computer program code are configured, with the at least one processor, to cause the apparatus to:
determine an identity of the transmitter apparatus from which the transmission request message was received;
if the transmitter apparatus is identified as not belonging to the first network, cause the wireless communication apparatus to transmit the transmission response message to the transmitter apparatus at least on the primary channel of the first network and on the primary channel of the second network.

44. The apparatus of claim 43, wherein the at least one memory and the computer program code are configured, with the at least one processor, to cause the apparatus to:
if the transmitter apparatus is identified as belonging to the first network, cause the wireless communication apparatus to transmit the transmission response message to the transmitter apparatus at least on the primary channel of the first network and not on the primary channel of the second network.

45. The apparatus of claim 42, wherein the at least one memory and the computer program code are configured, with the at least one processor, to cause the apparatus to:
determine from contents of the received transmission request message, a transmission criteria for transmitting the transmission response message; and
cause the wireless communication apparatus to transmit the transmission response message to the transmitter apparatus if the transmission criteria is fulfilled.

46. The apparatus of claim 38, wherein the first network and the second network each form a basic service set of an IEEE 802.11 network.

47. The method of claim 38, wherein the transmission request message and the transmission response message are used to reserve designated at least one frequency channel for said data transmission.
